(19) United States
(12) Patent Application Publication
(10) Pub. No.: US 2026/0140869 A1
(43) Pub. Date: May 21, 2026

(54) MEMORY SYSTEM, CONTROLLER, OPERATING METHOD, STORAGE MEDIUM, AND PROGRAM PRODUCT

(71) Applicant: YANGTZE MEMORY TECHNOLOGIES CO., LTD., Wuhan (CN)

(72) Inventor: Tao XIONG, Wuhan (CN)

(21) Appl. No.: 19/178,403

(22) Filed: Apr. 14, 2025

(30) Foreign Application Priority Data
Nov. 15, 2024 (CN) 2024116400385

(51) Int. Cl. G06F 12/02

(52) U.S. Cl. CPC G06F 12/0246

(57) ABSTRACT

Examples of the present disclosure provides a memory system, a memory controller, an operating method, a computing readable storage medium and a computer program product, and the present disclosure relates to the technical field of semiconductors. The method includes: determining that a first die of a plurality of dies fails; obtaining valid data of the first die based on stored redundant data; and send a first program command sequence to second dies, wherein the first program command sequence includes a first program command and the valid data of the first die, and the second dies comprise other dies different from the first die among the plurality of dies, and reliability of the memory system can be improved.

### CROSS-REFERENCE TO RELATED APPLICATIONS

The present application claims priority to Chinese Patent Application No. 2024116400385, which was filed Nov. 15, 2024, and is hereby incorporated herein by reference in its entirety.

### TECHNICAL FIELD

The present disclosure relates to the field of semiconductor technologies, and in particular, to a memory system, a memory controller, an operating method, a computer readable storage medium, and a computer program product.

### BACKGROUND

In the memory system, the capacity of devices is increasing, typically including multiple dies, where a die may fail.

### SUMMARY

The example of the present disclosure provides a memory system, a memory controller, an operating method, a computer readable storage medium and a computer program product.

According to one aspect of examples of the present disclosure, there is provided a memory system, including: a plurality of dies including a first die; a memory controller coupled to the plurality of dies and configured to: determine that the first die fails; obtain valid data of the first die based on stored redundant data; and send a first program command sequence to second dies, wherein the first program command sequence includes a first program command and the valid data of the first die, and the second dies comprise other dies different from the first die among the plurality of dies.

In some examples, the memory controller is configured to obtain valid data stored on the first die based on redundant data stored in Redundant Arrays of Independent Disks (RAID).

In some examples, the memory system is configured with a first super block including a set of blocks sharing a same position in each plane of each of the plurality of dies, wherein the first super block includes a first block for storing check data for other block in the first super block.

In some examples, the memory controller is configured to: after determining that the first die fails, determine a second super block of the memory system, wherein the second super block includes a set of blocks sharing a same position in each plane of each of the second dies; and send the first program command sequence to the second dies, wherein the first program command sequence includes first physical addresses corresponding to blocks in the second super block that correspond to the second dies.

In some examples, the memory controller is configured to: after the determination of the second super block, trigger a garbage collection GC operation to write valid data in the first super block to the second super block.

In some examples, the memory controller is configured to: after the second super block is determined, send the first program command sequence to the second dies to write valid data of the first die to the second super block; and in response to the valid data of the first die having been written to the second super block, trigger a GC operation to write valid data of the second dies in the first super block to the second super block.

In some examples, the memory controller is further configured to: determine a recovery operation mode in response to a selection of a user;

receiving an operation instruction from a host during the GC operation, wherein the operation instruction is processed based on the recovery operation mode.

In some examples, the memory controller is further configured to: when the recovery operation mode is a first recovery operation mode, receive and execute a read operation instruction or a write operation instruction from the host; and when the recovery operation mode is a second recovery operation mode, receive a read operation instruction or a write operation instruction from the host and execute only the read operation instruction from the host.

In some examples, the memory controller is further configured to: receive a write operation instruction from the host during the GC operation; and perform a write operation on the second super block in response to the number of available second super block remaining above the GC startup waterline.

In some examples, the memory controller is further configured to: receive a re-initialization instruction from the host to perform an initialization operation on the plurality of dies.

In some examples, the memory controller is further configured to: decreasing the GC startup waterline when the first die fails.

In some examples, the memory controller is configured to: receive a power-on restart failure notification for the first die during a power-on initialization process to determine that the first die fails.

In some examples, the memory controller is configured to: obtain an abnormal state of the first die during execution of an operation command to determine that the first die fails.

In some examples, the memory controller is configured to: when the number of Grown Bad Blocks (GBBs) on one plane of the first die exceeds a predetermined threshold during execution of the operation command, determine that the first die fails.

According to another aspect of the present disclosure, there is provided a memory controller, including: a controller memory device configured to store control instructions; and a controller processor coupled to the controller memory device and configured to execute the control instructions to perform a process, including: determining that a first die of a plurality of dies fails; obtaining valid data of the first die based on stored redundant data; and sending a first program command sequence to second dies, wherein the first program command sequence includes a first program command and the valid data of the first die, and the second dies comprise other dies different from the first die among the plurality of dies.

In some examples, the process includes: obtaining valid data stored on the first die based on redundant data stored in RAID.

In some examples, a memory system is configured with a first super block including a set of blocks sharing a same position in each plane of each of the plurality of dies, wherein the first super block includes a first block for storing check data for other blocks in the first super block.

In some examples, the process includes: after determining that the first die fails, determining a second super block of the memory system, wherein the second super block includes a set of blocks sharing a same position in each plane of each of the second dies; and sending the first program command sequence to the second dies, wherein the first program command sequence includes a first physical addresses corresponding to blocks in the second super block that corresponds to the second dies.

In some examples, the process includes: after the second super block is determined, triggering a garbage collection GC operation to write valid data in the first super block to the second super block.

In some examples, the process includes: after the second super block is determined, sending the first program command sequence to the second dies to write valid data of the first die to the second super block; and in response to the valid data of the first die having been written to the second super block, triggering a GC operation to write valid data of the second dies in the first super block to the second super block.

In some examples, the process further includes: determining a recovery operation mode in response to a selection of a user; receiving an operation instruction from a host during the GC operation; and processing the operation instruction based on the recovery operation mode.

In some examples, when the recovery operation mode is a first recovery operation mode, receiving and executing a read operation instruction or a write operation instruction from the host; and

when the recovery operation mode is a second recovery operation mode, receiving a read operation instruction or a write operation instruction from the host and executing only the read operation instruction from the host.

In some examples, the process further includes: receiving a write operation instruction from the host during the GC operation; and performing a write operation on the second super block in response to the number of available second super block remaining above the GC startup waterline.

In some examples, the process further includes: receiving a re-initialization instruction from the host to perform an initialization operation on the plurality of dies.

In some examples, the process further includes: decreasing the GC startup waterline when the first die fails.

In some examples, the process includes: receiving a power-on restart failure notification for the first die during a power-on initialization process to determine that the first die fails.

In some examples, the process includes: obtaining an abnormal state of the first die during execution of an operation command to determine that the first die fails.

In some examples, the processing includes: when the number of Grown Bad Blocks (GBBs) on one plane of the first die exceeds a predetermined threshold during execution of the operation command, determining that the first die fails.

According to yet another aspect of the present disclosure, an operating method of a memory system is provided, including: determining that a first die of a plurality of dies fails; obtaining valid data of the first die based on stored redundant data; and sending a first program command sequence to second dies, wherein the first program command sequence includes a first program command and the valid data of the first die, and the second dies comprise other dies different from the first die among the plurality of dies.

In some examples, the obtaining valid data of the first die based on the stored redundant data includes: obtaining valid data stored on the first die based on redundant data stored in a RAID.

In some examples, a memory system is configured with a first super block including a set of blocks sharing a same position in each plane of each of the plurality of dies, wherein the first super block includes a first block for storing check data for other blocks in the first super block.

In some examples, the method further includes: after determining that the first die fails, determining a second super block of the memory system, wherein the second super block including a set of blocks sharing a same location in each plane of each of the second dies; the sending the first program command sequence to the second dies, wherein the first program command sequence includes a first program command and valid data of the first die includes: sending the first program command sequence to the second dies, wherein the first program command sequence includes first physical addresses corresponding to blocks in the second super block that correspond to the second dies.

In some examples, the sending the first program command sequence to the second dies includes: after the second super block is determined, triggering a garbage collection GC operation to write valid data in the first super block to the second super block.

In some examples, the sending the first program command sequence to the second dies includes: after the second super block is determined, sending the first program command sequence to the second dies to write valid data of the first die to the second super block; and the method further includes: in response to the valid data of the first die having been written to the second super block, triggering a GC operation to write valid data of the second dies in the first super block to the second super block.

In some examples, the method further includes: determining a recovery operation mode in response to a selection of a user; receiving an operation instruction from a host during the GC operation; and processing the operation instruction based on the recovery operation mode.

In some examples, the processing the operation instruction based on the recovery operation mode includes: when the recovery operation mode is a first recovery operation mode, receiving and executing a read operation instruction or a write operation instruction from the host; and when the recovery operation mode is a second recovery operation mode, receiving a read operation instruction or a write operation instruction from the host and executing only the read operation instruction from the host.

In some examples, the method further includes: receiving a re-initialization instruction from the host to perform an initialization operation on the plurality of dies.

In some examples, the method further includes: decreasing a GC startup waterline when the first die fails.

In some examples, the determining that the first die in the plurality of dies fails includes: receiving a power-on restart failure notification for the first die during a power-on initialization process to determine that the first die fails; or obtaining an abnormal state of the first die during execution of an operation command to determine that the first die fails; or when the number of Grown Bad Blocks (GBBs) on one plane of the first die exceeds a predetermined threshold during execution of the operation command, determining that the first die fails.

According to another aspect of the present disclosure, there is provided a computer readable storage medium, wherein when a control instruction in the computer readable storage medium is executed by a controller processor, the controller processor is enabled to perform the operating method as described above.

According to yet another aspect of the present disclosure, a computer program product includes a computer program/instruction, wherein the computer program/instruction, when executed by a processor, implements the operating method as described above.

According to the memory system, the memory controller, the operating method, the computer readable storage medium and the computer program product of the present disclosure, when it is determined that the first die fails, the valid data of the first die is obtained based on the stored redundant data; and the valid data of the first die is written into other dies different from the first die, so that the reliability of the memory system is improved.

It should be understood that the above general description and the following detailed description are only examples and explanatory, and do not limit the present disclosure.

### BRIEF DESCRIPTION OF THE DRAWINGS

The accompanying drawings, which are incorporated in and constitute a part of this specification, illustrate examples consistent with the present disclosure and serve to explain the principles of the present disclosure together with the description. Obviously, the drawings in the following description are only some examples of the present disclosure, and for those skilled in the art, other drawings can be obtained based on these drawings without creative efforts.

FIG. 1 illustrates a block diagram of an example system with a memory device according to an example of the present disclosure;

FIG. 2A exemplarily illustrates a block diagram of a memory system;

FIG. 2B exemplarily illustrates a block diagram of another memory system;

FIG. 2C exemplarily illustrates a block diagram of yet another memory system;

FIG. 3 illustrates a schematic circuit diagram of a memory apparatus including a peripheral circuit according to an example of the present disclosure;

FIG. 4 illustrates a schematic diagram of a peripheral circuit according to an example of the present disclosure;

FIG. 5 is a schematic architectural diagram of a memory system according to an example of the present disclosure;

FIG. 6 illustrates a flowchart of an operating method of a memory system according to some examples of the present disclosure;

FIG. 7 illustrates a flowchart of an operating method of a memory system according to some other examples of the present disclosure;

FIG. 8 illustrates a flowchart of an operating method of a memory system according to some other examples of the present disclosure;

FIG. 9 illustrates a flowchart of an operating method of a memory system according to some other examples of the present disclosure;

FIG. 10 illustrates a schematic diagram of a super block in a memory system according to some examples of the present disclosure;

FIG. 11 illustrates various cases where it is determined that a die fails according to some examples of the present disclosure;

FIG. 12 illustrates a flowchart of an operating method of a memory system according to some other examples of the present disclosure;

FIG. 13 illustrates a flowchart of an operating method of a memory system according to some other examples of the present disclosure;

FIG. 14 illustrates a flowchart of an operating method of a memory system according to some other examples of the present disclosure; and

FIG. 15 illustrates a flowchart of an operating method of a memory system according to some other examples of the present disclosure.

### DETAILED DESCRIPTION

Examples will now be described more comprehensively with reference to the accompanying drawings. However, the examples can be implemented in a variety of forms and should not be construed as limited to the examples set forth herein; rather, these examples are provided so that this disclosure will be thorough and complete and will fully convey the concepts of the examples to those skilled in the art. The same reference numbers refer to the same or similar parts in the drawings, so repeated descriptions thereof will be omitted.

Features, structures, or characteristics described in the present disclosure may be combined in one or more examples in any suitable manner. In the following description, numerous details are provided to give a thorough understanding of examples of the disclosure. However, those skilled in the art will appreciate that the technical solutions of the present disclosure may be practiced without one or more of the details, or other methods, components, apparatus, operations, etc., may be employed. In other instances, well-known methods, apparatus, implementations, or operations are not shown or described in detail to avoid obscuring aspects of the present disclosure.

The drawings are merely schematic illustrations of the present disclosure, and the same reference numbers in the drawings denote the same or similar parts, so repeated descriptions thereof will be omitted. Some block diagrams shown in the figures do not necessarily correspond to physically or logically separate entities. These functional entities may be implemented in software form, or in at least one hardware module or integrated circuit, or in different networks and/or processor devices and/or microcontroller devices.

The flowcharts shown in the drawings are merely illustrative, and do not necessarily include all content and operations, and do not have to be executed in the order described. For example, some operations may be further decomposed, and some operations may be combined or partially combined, so the actual execution order may be changed according to actual situations.

In this specification, the terms “a”, “an”, “this”, “the”, and “at least one” are to indicate that there is at least one element/component/etc.; the terms “including”, “comprising”, and “having” are to indicate open-ended inclusion and mean that there may be additional elements/components/etc. in addition to the listed elements/components/etc.; the terms “first”, “second”, and “third” and the like are only used as labels, and are not limiting to the number of objects thereof.

The following describes terms involved in the present disclosure:

DPPM, the number of defects per million, with the English original text being Defect Part Per Million, mainly refers to the ratio that a die of the memory apparatus fails herein.

GBB, with the English original text being Grown Bad Block, refers to bad blocks of a memory apparatus found in a normal working process after a memory device (such as an SSD) leaves a factory.

The SPB, with the English original text being Super Block, refers to a set formed by some physical blocks in a memory device (for example, an SSD), and the set usually includes a certain physical block in all planes on all dies.

The GC (GC) startup waterline refers to a threshold value and represents available space, and it may be the number of SPBs or the percentage of available space. In some examples, it is characterized by available SPB number. GC is triggered when the number of available SPBs is below (or equal to) the value.

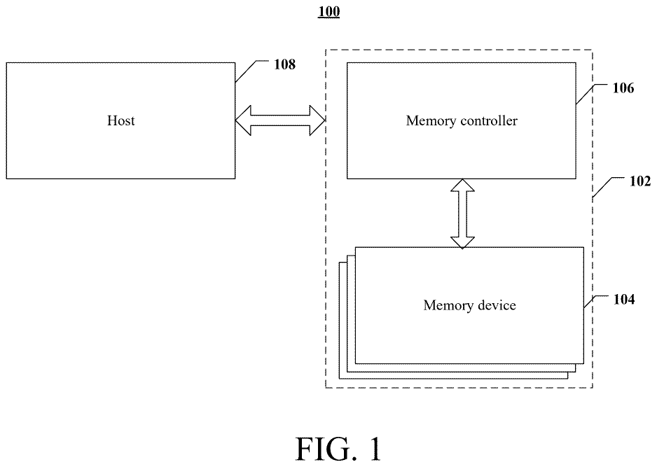

FIG. 1 shows a block diagram of an example system with a memory device according to an example of the present disclosure. The system 100 may be a mobile phone, desktop computer, portable computer, tablet computer, vehicle computer, game machine, printer, positioning device, wearable electronic device, smart sensor, virtual reality (VR) device, augmented reality (AR) device, or any other suitable electronic device having memory device therein. As shown in FIG. 1, system 100 may include a host 108 and a memory system 102 having one or more memory apparatus 104 and a memory controller 106.

The host 108 may be a processor (e.g., a central processing unit (CPU)) or a system on chip (SoC) (e.g., an application processor (AP)) of the electronic device. The host 108 may be coupled to the memory controller 106 and configured to send data to or receive data from the memory apparatus 104 through the memory controller 106. For example, the host 108 may send program data in a program operation or receive read data in a read operation. The host 108 is configured to receive an instruction and a command from and send an instruction and a command to the memory controller 106 of the memory system 102, and perform or implement various functions and operations provided in the present disclosure, which will be described below.

The memory apparatus 104 may be any memory apparatus disclosed in the present disclosure, for example, a NAND flash memory apparatus that includes a page buffer having multiple portions. Note that the NAND flash memory is only one example of a memory apparatus for illustrative purposes. The memory apparatus 104 may include any suitable non-volatile memory, such as NOR flash memory, Ferroelectric Random-Access Memory (FeRAM), Phase Change Memory (PCM), Magnetoresistive Random Access Memory (MRAM), Spin-transfer Torque Random Access Memory (STT-RAM), Resistive Random-Access Memory (RRAM), or the like. In some implementations, the memory apparatus 104 includes three-dimensional (3D) NAND flash memory.

The memory controller 106 may be implemented by a microprocessor, a microcontroller (also referred to as a microcontroller unit (MCU)), a digital signal processor (DSP), an application-specific integrated circuit (ASIC), a field-programmable gate array (FPGA), a programmable logic device (PLD), a state machine, gated logic, discrete hardware circuit, and other suitable hardware, firmware, and/or software configured to perform the various functions described in detail below.

According to some implementations, the memory controller 106 is coupled to the memory apparatus 104 and the host 108, and is configured to control the memory apparatus 104. The memory controller 106 may manage the data stored in the memory apparatus 104 and communicate with the host 108. In some implementations, the memory controller 106 is designed to operate in a low duty cycle environment, such as a Secure Digital (SD) card, a Compact Flash (CF) card, a Universal Serial Bus (USB) flash drive, or other media for use in the electronic devices (e.g., personal computers, digital cameras, mobile phones, etc.). In some implementations, the memory controller 106 is designed for operating SSDs in high duty cycle environments or as an Embedded MultiMedia Card (eMMC) for data memory device and enterprise storage arrays of mobile devices (e.g., smartphones, tablets, laptops, etc.). The memory controller 106 may be configured to control operations of the memory apparatus 104, e.g., read, erase, and program operations, by providing instructions, such as read instructions, to the memory apparatus 104. For example, the memory controller 106 may be configured to provide read instructions to the peripheral circuit of the memory apparatus 104 to control the read operations. The memory controller 106 May also be configured to manage various functions regarding data stored or to be stored in the memory apparatus 104, including but not limited to bad block management, garbage collection (GC), logical-to-physical address translation, wear leveling, and the like. In some implementations, the memory controller 106 is further configured to process an error correcting code (ECC) with respect to data read from or written to the memory apparatus 104. The memory controller 106 may also perform any other suitable function, such as formatting the memory apparatus 104.

The memory controller 106 may communicate with external devices (e.g., the host 108) according to a particular communication protocol. For example, the memory controller 106 may communicate with an external device through at least one of various interface protocols, such as a USB protocol, a Multi-Media Card (MMC) protocol, a Peripheral Component Interconnect (PCI) protocol, a Peripheral Component Interconnect Express (PCI-E) protocol, an Advanced Technology Attachment (ATA) protocol, a Serial ATA protocol, a Parallel ATA protocol, a Small Computer System Interface (SCSI) protocol, an Enhanced Small Drive Interface (ESDI) protocol, an Integrated Drive Electronics (IDE) protocol, a Firewire protocol, and the like.

The memory controller 106 and the one or more memory apparatus 104 may be integrated into various types of memory devices, for example, being included in the same package (e.g., Universal Flash Storage (UFS) package or eMMC package). For example, the memory system 102 may be implemented and packaged into different types of terminal electronic products.

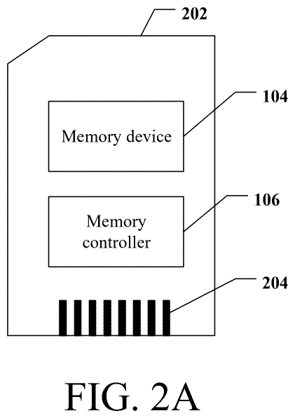

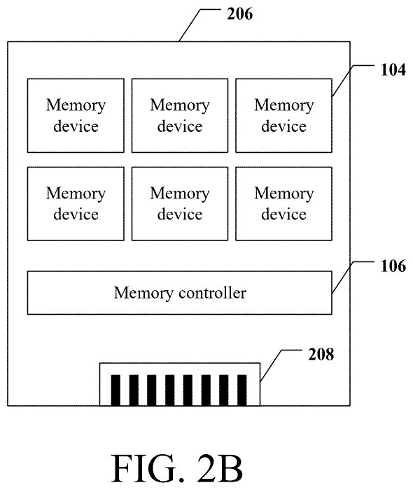

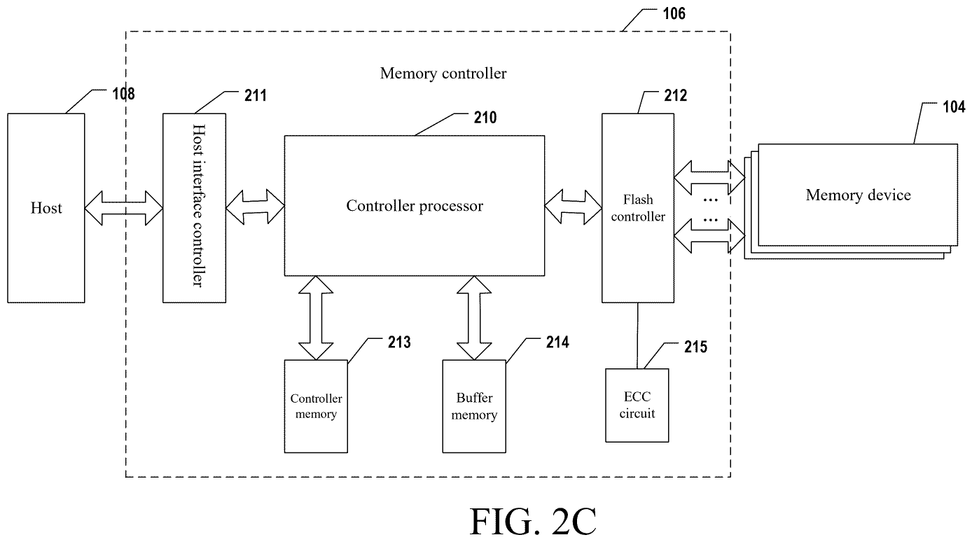

In some examples as shown in FIG. 2A, the memory controller 106 and the memory apparatus 104 may be integrated into the memory card 202. The memory card 202 may include a PC card (personal computer memory card international association (PCMCIA) card), a CF card, a smart media (SM) card, a memory stick, a multimedia card (MMC), an SD card, a UFS, and the like. The memory card 202 may also include a memory card connector 204 that couples the memory card with a host (e.g., the host 108 in FIG. 1).

In another example as shown in FIG. 2B, the memory controller 106 and the plurality of memory apparatus 104 may be integrated into the solid-state disk 206. The solid-state disk 206 may also include a solid-state disk connector 208 that couples the solid-state disk 206 with a host (e.g., the host 108 in FIG. 1). In some implementations, the storage capacity and/or operating speed of the solid-state disk 206 is greater than the storage capacity and/or operating speed of the memory card 202.

FIG. 2C illustrates a schematic diagram of an example memory controller having a memory system according to an example of the present disclosure. As shown in FIG. 2C, the memory controller 106 is coupled to the host 108 and the one or more memory apparatus 104 respectively, and is configured to control the host 108 to send data to the memory apparatus 104, or read data from the memory apparatus 104 and return the data to the host 108. The memory controller 106 includes at least a controller processor 210, a host interface controller 211, a flash memory controller 212, a controller memory device 213, a buffer memory device 214, and an error correction code (ECC) circuit 215.

The controller processor 210 may be configured to execute the control logic and the algorithm of the memory controller, including but not limited to functions such as address mapping, garbage collection, and wear leveling. The controller processor 210 may be implemented by an embedded processor or an FPGA.

The host interface controller 211 is coupled to the host 108 and the controller processor 210 respectively, and may be a communication interface component between the host and the memory controller, and is responsible for data transmission between the host and the memory controller, including read and write of the data, and receiving and sending of the commands. In general, it supports various interfaces (such as Serial Advanced Technology Attachment (SATA), PCIe) and protocols (such as Advanced Host Controller Interface (AHCI), Non-Volatile Memory Express (NVMe)), and provides a data transmission function.

The flash memory controller 212 is coupled to the memory apparatus 104 and the controller processor 210 respectively, and may be a communication interface component between the memory apparatus and the memory controller.

The controller memory device 213 is coupled to the controller processor 210, and may include a storage area for storing instructions and data. The controller memory device 213 may employ storage medium such as NOR flash, NAND flash, or RAM.

The buffer memory device 214, coupled to the controller processor 210, may include a component configured to temporarily store data, and may further be configured to buffer instructions and data. It may employ high-speed memory device such as a Dynamic Random-Access Memory (DRAM) or a Static Random-Access Memory (SRAM).

The ECC circuit 215 is configured for error detection and correction of data read from the memory apparatus. The ECC check data may be stored in the reserved space of the memory apparatus 104 for checking of the data.

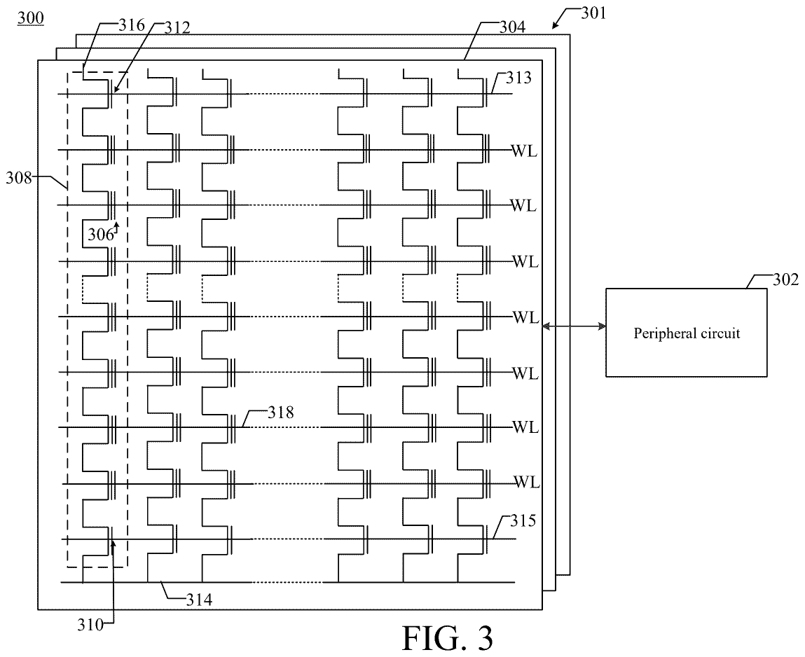

FIG. 3 illustrates a schematic circuit diagram of a memory device including a peripheral circuit according to some examples of the present disclosure. The memory apparatus 300 may be an example of the memory apparatus 104 in FIG. 1. The memory apparatus 300 may include a memory cell array 301 and a peripheral circuit 302 coupled to the memory cell array 301. The memory cell array 301 may be a NAND flash memory cell array in which memory cells 306 are provided in the form of an array of memory strings 308 of NAND flash memory, each memory string 308 extending vertically above a substrate (not shown). It may be understood that the peripheral circuit 302 may be configured to perform an operation corresponding to the instruction according to the received instruction of the memory controller 106.

In some examples, each memory string 308 includes a plurality of memory cells 306 coupled in series and stacked vertically. Each memory cell 306 may hold a continuous analog value, e.g., voltage or charge, depending on the number of electrons trapped within the region of the memory cell 306. Each memory cell 306 may be a floating gate type memory cell including a floating gate transistor or a charge trapping type memory cell including a charge trapping transistor.

In some examples, each memory cell 306 may store 1-bit data or 2-bit data or more bit data, for example, it may be a single-level cell (SLC) type, a multi-level cell (MLC) type, a triple-level cell (TLC) type, a quad-level cell (QLC) type, or a higher-level type. P (p is a positive integer) layer cell(s) may have 2P states (for example, one state corresponds to one threshold voltage distribution interval), and therefore may store p-bit data. The SLC type memory cell may have 2 states, and thus may store 1 bit of data; the MLC type memory cell may have 4 states, and thus may store 2 bits of data; the TLC type memory cell may have 8 states, and thus may store 3 bits of data; the QLC type memory cell may have 16 states, and thus may store 4 bits of data, and so on. Among the 2P states, one erase state and 2P-1 program states may be included. The p-level cell type NAND flash memory may program and/or read data page by page. During a program operation, a p-level cell type NAND flash memory cell is programmed to have 2P states, one memory cell being programmed to a target state of the 2P states, e.g., it is said to be in a target program state. As shown in FIG. 3, each memory string 308 may include a source select gate (SSG) 310 at its source terminal and a drain select gate (DSG) 312 at its drain terminal. SSG 310 and DSG 312 may be configured to activate a selected memory string 308 during read and program operations.

In some examples, the sources of the memory strings 308 in a same block 304 are coupled by a same source line (SL) 314 (e.g., a common SL). For example, all memory strings 308 in the same block 304 have an array common source (ACS). As shown in FIG. 3, the memory string 308 may be organized into a plurality of blocks 304, each of which may have a common source line 314 (e.g., coupled to ground). In some examples, each block 304 is a basic data unit for an erase operation, e.g., all memory cells 306 on the same block 304 are erased simultaneously.

In some examples, the transistors of the DSG 312 of each memory string 308 are coupled to a respective bit line (BL) 316 from which data may be read or written via an output bus (not shown). Each memory string 308 may be configured to be selected or deselected by applying a selection voltage (e.g., above a threshold voltage of a transistor having a DSG 312) or deselection voltage (e.g., 0 V) to the respective DSG 312 via one or more DSG lines 313 and/or applying a selection voltage (e.g., above a threshold voltage of a transistor having a SSG 310) or deselection voltage (e.g., 0 V) to the respective SSG 310 via one or more SSG lines 315.

As shown in FIG. 3, the memory cells 306 of a memory string 308 may be coupled by word lines (WL) 318 that select which row of memory cells 306 is affected by read and program operations. The peripheral circuit 302 may be coupled to the memory cell array 301 through the bit line 316, the word line 318, the source line 314, the SSG line 315, and the DSG line 313. The peripheral circuit 302 may include any suitable analog, digital, and mixed-signal circuit for facilitating operation of the memory cell array 301 by applying voltage signal and/or current signal to and sensing voltage signal and/or current signal from each memory cell 306 that becomes the target of the operation via the bit line 316, the word line 318, the source line 314, the SSG line 315, and the DSG line 313. The peripheral circuits 302 may include various types of peripheral circuits formed using metal-oxide-semiconductor (MOS) technology.

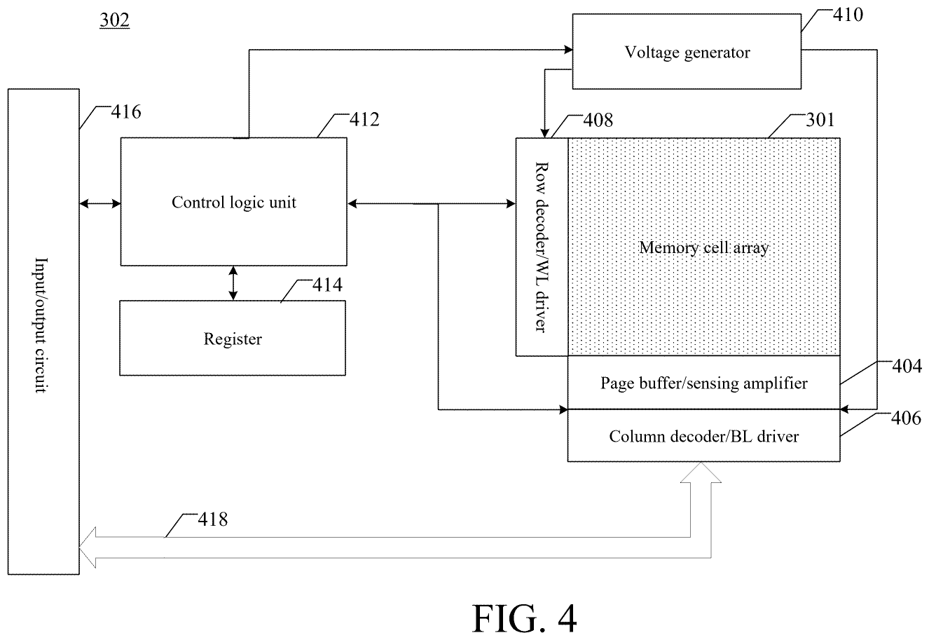

FIG. 4 is a schematic diagram of a peripheral circuit according to an example of the present disclosure. As shown in FIG. 4, the peripheral circuit 302 may include a page buffer/sense amplifier 404, a column decoder/BL driver 406, a row decoder/WL driver 408, a voltage generator 410, a control logic unit 412, a register 414, an input/output (I/O) circuit 416, and a data bus 418. It should be understood that in some examples, additional peripheral circuits not shown in FIG. 4 may also be included.

In some examples, the page buffer/sense amplifier 404 may be configured to read data from and program (write) data to the memory cell array 301 according to the control signal from the control logic unit 412. For example, the page buffer/sense amplifier 404 may store a page of program data (write data) to be programmed into the memory cell array 301. As another example, the page buffer/sense amplifier 404 may also sense a low power signal from the bit line 316 representing a data bit stored in the memory cell 306 and amplify a small voltage swing to an identifiable logic level in a read operation. The column decoder/BL driver 406 may be configured to be controlled by a control logic unit 412 and to select one or more memory strings 308 by applying a bit line voltage generated from the voltage generator 410.

The row decoder/WL driver 408 may be configured to be controlled by the control logic unit 412 and select/deselect the block 304 of the memory cell array 301 and select/deselect the word line 318 of the block 304. The row decoder/WL driver 408 may also be configured to drive word lines 318 using word line voltage generated from the voltage generator 410. In some examples, the row decoder/WL driver 408 may also select/deselect and drive SSG line 314 and DSG line 313. The voltage generator 410 may be configured to be controlled by the control logic unit 412 and generate word line voltage (e.g., read voltage, program voltage, pass voltage, local voltage, verify voltage, etc.), bit line voltage, and source line voltage, etc., to be supplied to the memory cell array 301.

The control logic unit 412 may be coupled to each portion of the peripheral circuit 302 and configured to control operation of each portion. The register 414 may be coupled to the control logic unit 412 and may include status register, command register, and address register for storing status information, command operation code (OP code), and command address for controlling operation of each peripheral circuit. The input/output circuit 416 may be coupled to the control logic unit 412 and act as a control buffer to buffer and relay the control command received from a host (not shown in FIG. 4) to the control logic unit 412 and to buffer and relay status information received from the control logic unit 412 to the host. The input/output circuit 416 may also be coupled to the column decoder/bit line driver 406 via a data bus 418 and act as a data I/O interface and a data buffer to buffer and relay data to or from the memory cell array 301.

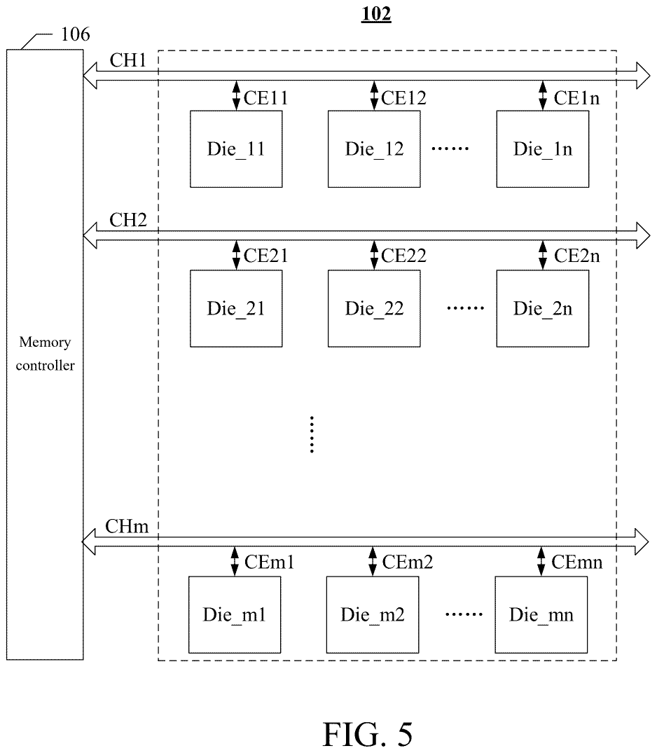

FIG. 5 is a schematic architectural diagram of a memory system according to an example of the present disclosure. As shown in FIG. 5, the memory system 102 has one or more memory apparatuses 104 and a memory controller 106. The memory controller 106 is coupled to the one or more memory apparatuses 104 through a plurality of physical channels CH 1, CH 2, . . . , CH m, and sends control command or transmits data to the memory apparatus 104. The memory apparatus 104 includes one or more dies (also referred to as LUNs). One or more dies Die_1l, . . . , Die_1n, Die_2l, . . . , Die_2n, . . . , Die_ml, . . . , Die_mn are connected on each physical channel. Each die corresponds to a respective Chip Enable (CE) signal CE1l, . . . , CE1n, CE2l, . . . , CE2n, . . . , CEml, . . . , CEmn. The control command sent by the memory controller 106 to the memory apparatus 104 includes a CE signal from which a corresponding die in the physical channel is selected, for example, the target die of the control command is selected.

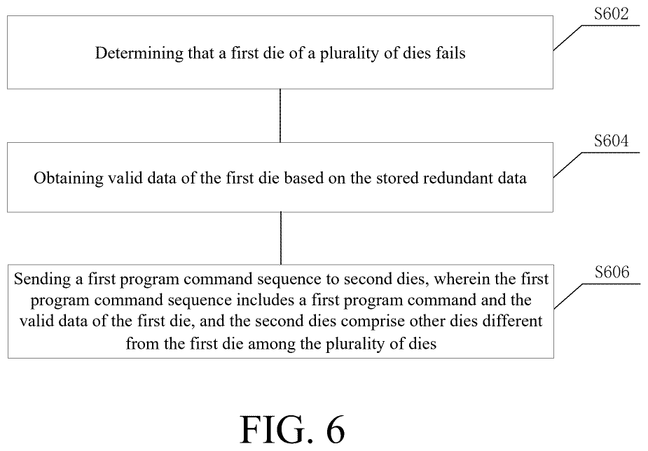

FIG. 6 illustrates a flowchart of an operating method of a memory system according to some examples of the present disclosure. In the examples, the memory system includes a plurality of dies, and the method is applied to a memory controller.

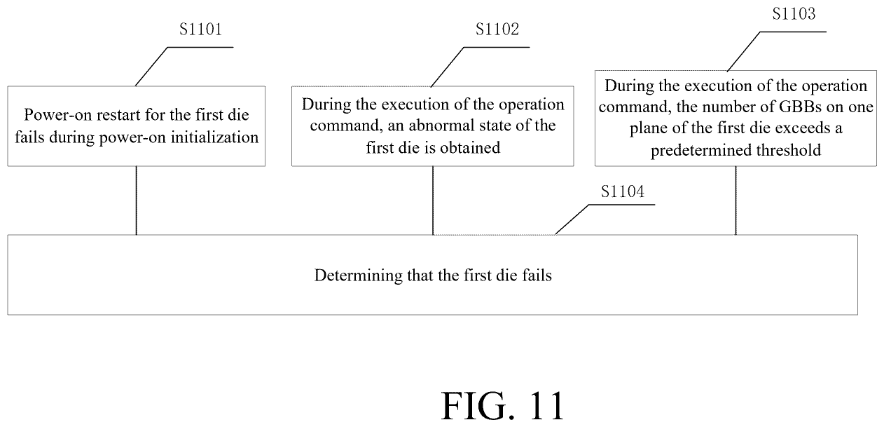

As shown in FIG. 6, at S602, determining that a first die of a plurality of dies fails. It may be determined that the die fails in various cases, which will be described below with reference to the example of FIG. 11.

At S604, obtaining valid data of the first die based on the stored redundant data. In some examples, the RAID stores the redundant data, thereby valid data of the first die is obtained based on the redundant data stored on the RAID.

At S606, sending a first program command sequence to second dies, wherein the first program command sequence includes a first program command and the valid data of the first die, and the second dies comprise other dies different from the first die among the plurality of dies.

In the foregoing examples, when it is determined that a die fails, valid data of the die is obtained based on redundant data, and the valid data is stored in another die that works normally, so that the memory system continues to work normally, thereby improving reliability of the memory system.

In some examples, when it is determined that the first die fails, a flag is set for the first die to indicate that the first die fails. In some examples, a corresponding flag bit is set for each die, e.g., 0 indicates normal and 1 indicates failure; or conversely, 1 indicates normal and 0 indicates failure, and is stored in the memory device of the controller, and stored in the system data of the memory apparatus. In this way, when data is written to the memory apparatus, it is determined, through the flag, that the first die fails, and a write operation on the first die will no longer be performed.

FIG. 11 illustrates various cases where it is determined that a die fails according to an example of the present disclosure. In this example, the memory controller will determine that the die fails under various cases. As shown in FIG. 11, at S1101, a power-on restart failure notification for the first die is received during power-on initialization. At S1102, during the execution of the operation command, the abnormal state of the first die is obtained; At S1103, during the execution of the operation command, the number of Grown Bad Blocks (GBBs) on one plane of the first die exceeds a predetermined threshold; and when any one of the conditions S1101-S1103 occurs, it is determined that the first die fails (S1104). In some examples, during operation, the number of GBB on a certain plane of a certain die exceeds a predetermined value, where the predetermined value may be determined by adding a little margin, such as 4, to the number of predicted GBB for a Nand, and a detection of whether the die fails is made each time the GBB is recorded.

In the foregoing example, a plurality of cases where determining that a die fails are provided, and corresponding processing is performed for these cases, thereby improving reliability and flexibility of the memory system.

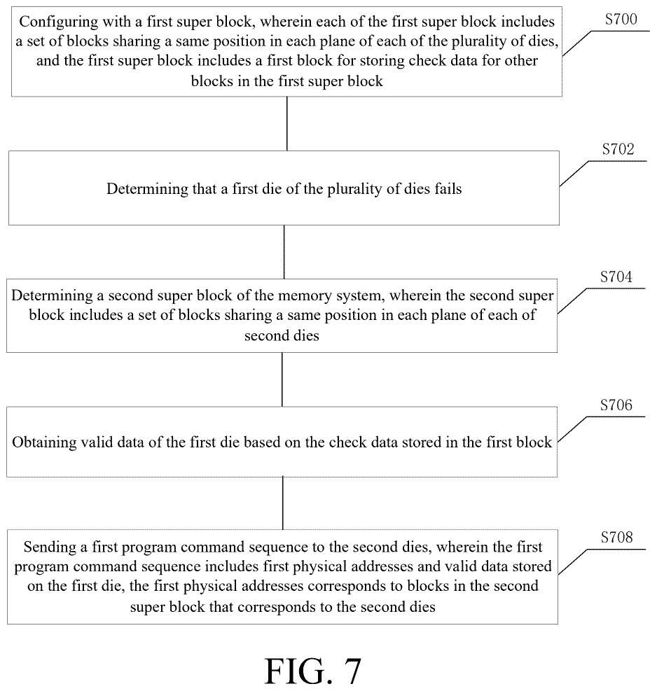

FIG. 7 illustrates a flowchart of an operating method of a memory system according to some other examples of the present disclosure. In the examples, the memory system stores data based on Super Block.

As shown in FIG. 7, at S700, the memory system is configured with a plurality of first super blocks, each of the first super blocks includes a set of blocks sharing a same position in each plane of each of the plurality of dies, the first super blocks include a first block for storing check data for other blocks in the first super block.

At S702, the memory controller determines that a first die of the plurality of dies fails. For example, in the case shown in FIG. 11, it is determined that the first die fails.

At S704, the memory controller determines one or more second super blocks of the memory system, the second super block include a set of blocks sharing a same position in each plane of each of second dies, the second dies do not include the first die.

At S706, valid data of the first die is obtained based on the check data stored in the first block of the first super block. The memory controller can recover valid data of the first die through data of a block corresponding to other die in the same super block and check data stored in the first block.

At S708, the memory controller sends a first program command sequence to the second dies, wherein the first program command sequence includes first physical addresses and valid data stored on the first die, the first physical addresses correspond to blocks in the second super block that corresponds to the second dies.

In the foregoing example, before a die fails, data is stored in a memory system in a manner of a first super block, and when a first die fails, valid data of the first die is obtained based on check data stored in the first super block, a second super block that does not include the first die is created, and the valid data of the first die is stored on the second super block. In this way, even if the first die fails, the memory system can still continue to be used, thereby improving reliability of the memory system.

In some examples, the failed first die includes one or more dies, and the second dies includes one or more dies that do not fail.

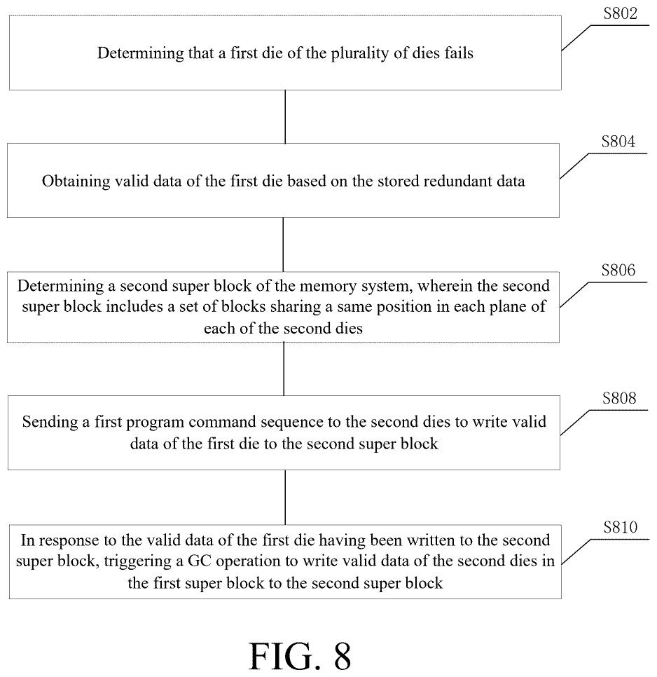

FIG. 8 illustrates a flowchart of a method of operating a memory system according to some other examples of the present disclosure. In the examples, the memory system is configured with a first super block to store data before the die fails.

As shown in FIG. 8, at S802, the memory controller determines that a first die of the plurality of dies fails.

At S804, obtaining valid data of the first die based on the stored redundant data.

At S806, determining a second super block of the memory system, wherein the second super block includes a set of blocks sharing a same position in each plane of each of the second dies.

At S808, sending a first program command sequence to the second dies to write valid data of the first die to the second super block. The valid data of the first die may be written to the second super block by a program command.

At S810, in response to all valid data of the first die being written to the second super block, triggering a GC operation to write valid data of other dies in the first super block to the second super block. The timing of triggering the GC operation may be selected on demand.

It should be noted that the sequence of S804 and S806 in the foregoing examples may be interchanged, and is not limited herein.

In the foregoing example, when the first die fails, the valid data of the first die is first written to the second super block, then the GC operation is triggered, and valid data of other dies in the first super block is written to the second super block, so that the data processing of the first die can be completed as soon as possible, and the processing efficiency is improved; and the timing of triggering the GC operation can be selected on demand, which is more flexible. The data is moved by triggering the GC operation, the existing functions and mechanisms of the system are better utilized, and the implementation is more convenient.

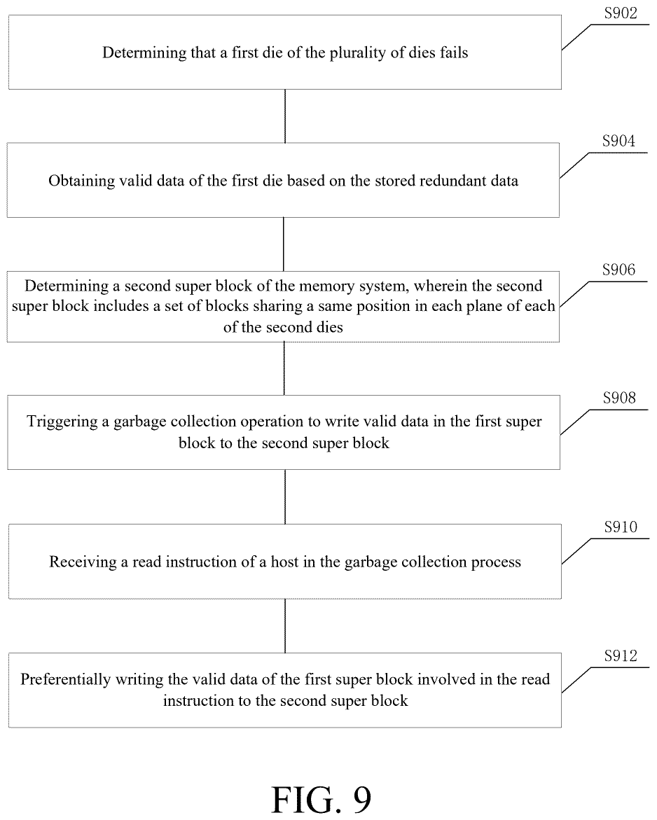

FIG. 9 illustrates a flowchart of a method of operating a memory system according to some other examples of the present disclosure. In the examples, the memory system is configured with a first super block to store data.

As shown in FIG. 9, at S902, the memory controller determines that a first die of the plurality of dies fails.

At S904, obtaining valid data of the first die based on the stored redundant data.

At S906, determining a second super block of the memory system, the second super block includes a set of blocks sharing a same location in each plane of each of the second dies, the second dies do not include the first die. The second dies may include all the other dies except for the first die.

At S908, after the second super block is determined, triggering a GC operation of all data to write the valid data in the first super block to the second super block. During a GC operation process, the existing first super block may be gradually released to generate the new second super block, to write all valid data in the first super block to the second super block.

In the foregoing examples, when it is determined that the first die fails, the second super block is generated, then the GC operation is triggered, and the valid data in the first super block is written to the second super block. In this way, not only valid data of the first die is written, but also valid data of other die is written, such that rewrite efficiency is improved.

In some examples, the process of writing the valid data of the first super block to the second super block in the GC operation further includes the following operations:

At S910, a read instruction of a host is received in a garbage collection process.

At S912, if the read instruction reads the valid data of the first die, the valid data of the first super block involved in the read instruction is preferentially written to the second super block.

In the foregoing examples, based on the read instruction of the host, valid data related to the read instruction is preferentially written to the second super block from the first super block, so that the read efficiency can be improved.

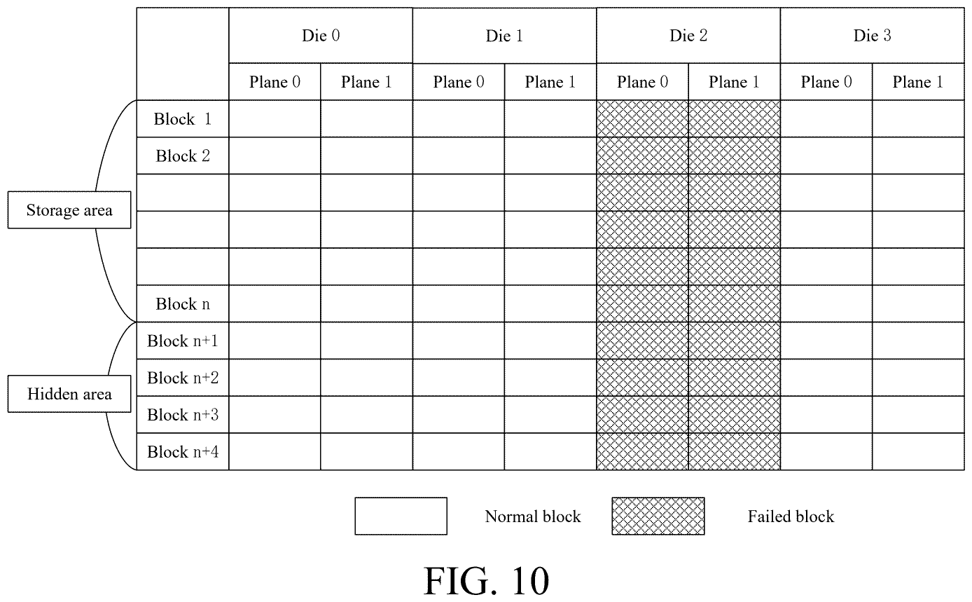

FIG. 10 shows an example of a schematic diagram of a super block in some memory systems in the present disclosure. As shown in FIG. 10, the memory system includes 4 dies: die 0, die 1, die 2, and die 3. Each die includes 2 planes: plane 0 and plane 1. A storage area and a hidden area are included in each die. When all the dies are normal, the memory system is configured with a plurality of first super blocks, Block 1, Block 2, . . . , Block n, Block n+1, . . . , etc. When it is determined that die 2 fails, The block in die 2 is marked as a failed block. At this point, the second super block generated by the memory system no longer contains the block in die 2.

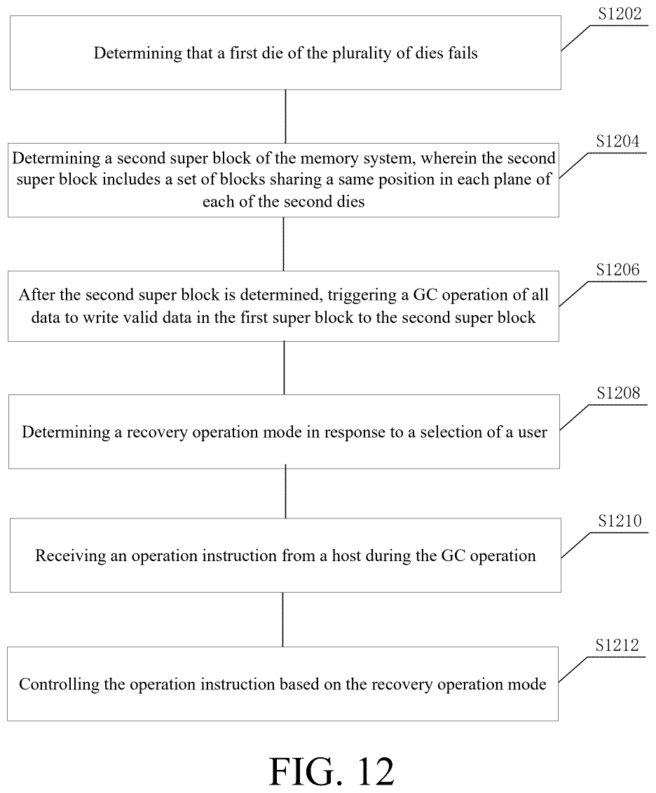

FIG. 12 illustrates a flowchart of a method of operating a memory system according to some other examples of the present disclosure.

As shown in FIG. 12, at S1202, the memory controller determines that a first die of the plurality of dies fails.

At S1204, determining a second super block of the memory system, wherein the second super block includes a set of blocks sharing a same position in each plane of each of the second dies.

At S1206, after the second super block is determined, triggering a GC operation on all data to write valid data in the first super block to the second super block, wherein the valid data of the first die is obtained based on the stored redundant data.

At S1208, determining a recovery operation mode in response to a selection of a user.

At S1210, receiving an operation instruction from a host during the GC operation.

At S1212, controlling the operation instruction based on the recovery operation mode. In some examples, when the recovery operation mode is the first recovery operation mode, a read operation instruction or a write operation instruction from the host is received and executed. In some examples, when the recovery operation mode is the second recovery operation mode, a read operation instruction or a write operation instruction from the host is received, and only the read operation instruction from the host is executed.

It should be noted that, step S1208 may occur after the die fails, or may occur before the die fails, and is preconfigured.

In the above example, during the GC operation when the die fails, the operation instruction from the host is controlled according to the recovery operation mode selected by the user, which can better respond to the operation instruction of the client during the data movement, and better meet the requirements of the user.

In some examples, the processing after the die fails includes processing of system SPB data and processing of host SPB data. The system SPB data may include slice data and journal data of L2P, the two parts are related to the time when the host data is written into, and are refreshed when the host data is written into; the system SPB data further includes some data required to be stored on a disk, such as various logs, various smart logs, and some data structures that need to be used by firmware, and these data needs to be rewritten when processing starts after a die fails; and the system data sometimes further includes some data required to be stored when a power down occurs, as well as some data that needs to be used when some debugging occurs, typically referred to as Coredump, and these data does not need to be rewritten preferentially. In general, some data related to the disk in the system data needs to be rewritten preferentially, and some data related to the host data is rewritten when the host data is written.

The data of the System SPB is preferentially processed, the rewritten of the System SPB data is triggered, and the RAID logic is recalculated. Then, data processing of the Host SPB is performed, an all-disk GC is triggered, and RAID logic is recalculated.

In the GC process, the data structure is to record which SPBs have completed GC, so as to facilitate the scenario of power-on after power-off. In some examples, a super block management table is maintained in the memory controller, and the super block management table records whether each of the first super block has completed GC. The super block management table is stored into the memory apparatus before the system is powered off, and is loaded from the memory apparatus to the memory controller when the system is powered on. The first super block that has completed the GC may be released, and the released first super block may be configured to generate the second super block.

The response to the host write command can be automatically adjusted during the GC repair process, and according to a common method, one SPB is released per GC, and one SPB is written by the host, so that the number of available SPBs is ensured to be kept at the GC startup waterline. In a repair process, a response to a host read command falling on a failed die is attempted by using a normal read, and after the attempt fails, RAID is triggered to recover valid data on the die. During the repair process, the full disk GC is continuously triggered to be completed without a host command.

In some examples, the memory system supports IO during processing after the die fails, with I/O performance in different recovery modes being affected to different degrees. For example, performance priority mode, recovery priority mode, balanced mode, and strict mode are included. For example:

The first operation mode may include:
a. I/O performance is preferred, its recovery duration is longer, but the I/O performance is less affected.
b. recovery is preferred, its recovery duration is shorter, but I/O performance is affected more severely.
c. balanced mode, default mode, and is the compromise of the above two solutions.

The second Operation mode:
d. strict mode, read-only mode is entered directly after the die fails.

In the foregoing example, through the user selecting different recovery operation modes, the user is supported to select a controllable recovery processing time level.

In some examples, a fast recovery method is further provided, for example, in a strict mode, a read-only mode is entered after a die fails, and the failure of the die is reported to a host, the host may notify the SSD to re-initialize by using a predetermined instruction, an initialization process takes a short time (for example, 1 to 3 minutes), and all data will be lost.

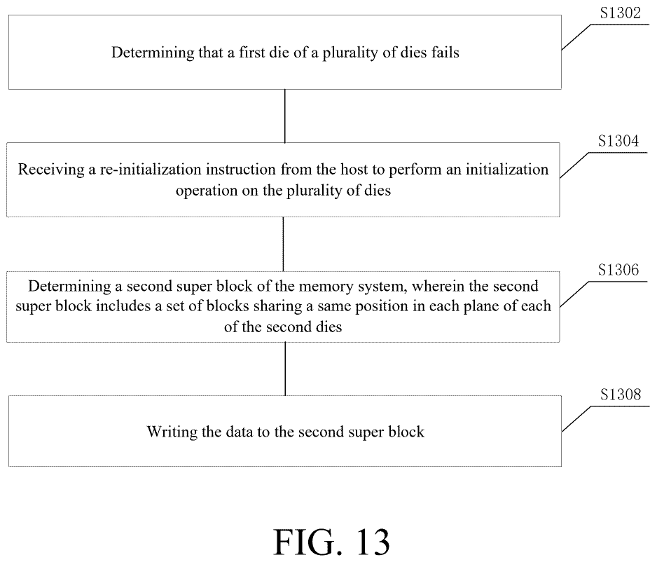

FIG. 13 illustrates a flowchart of a method of operating a memory system according to some other examples of the present disclosure. In the examples, the memory system is configured with a first super block to store data.

As shown in FIG. 13, at S1302, the memory controller determines that a first die of the plurality of dies fails.

At S1304: The memory controller receives a re-initialization instruction from the host to perform an initialization operation on the plurality of dies.

At S1306, determining a second super block of the memory system, wherein the second super block includes a set of blocks sharing a same position in each plane of each of the second dies, the second dies include all the other dies except for the first die.

At S1308, receiving a write operation instruction from a host, and writing to-be-written data into a second super block.

In the foregoing example, when the die fails, the die is directly initialized according to the instruction of the host, and newly written data is written into the second super block after initialization is completed, so that the implementation is faster.

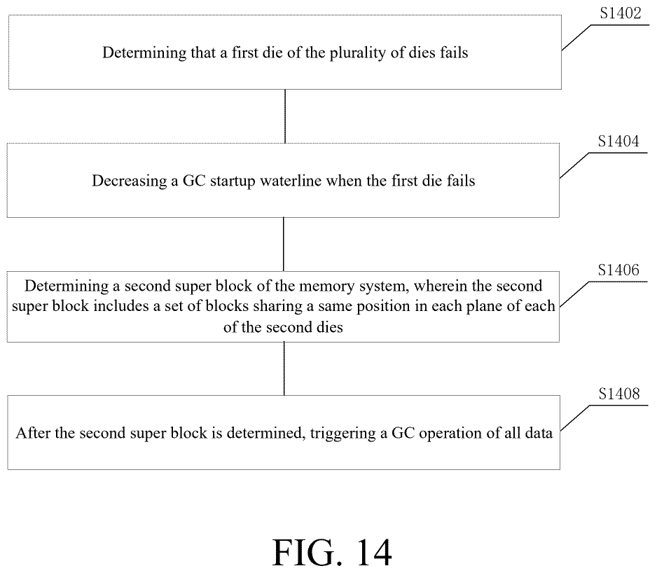

FIG. 14 illustrates a flowchart of a method of operating a memory system according to some other examples of the present disclosure. In the examples, the memory system is configured with a first super block to store data.

As shown in FIG. 14, at S1402, the memory controller determines that a first die of the plurality of dies fails.

At S1404, decreasing a GC startup waterline when the first die fails. For example, on an SQ-based 8T SSD, the GC startup waterline may be adjusted from original 8 to 4, thereby keeping Random Write (RW) performance substantially unchanged.

At S1406: determining a second super block of the memory system, wherein the second super block includes a set of blocks sharing a same position in each plane of each of the second dies.

At S1408, after the second super block is determined, triggering a GC operation of all data to write valid data in the first super block to the second super block.

In the foregoing examples, when a die fails, the GC startup pipeline is decreased, thereby ensuring that read-write performance remains substantially unchanged.

In some examples, after the foregoing solution is used for the eSSD, reliability of the eSSD is significantly improved. After 1 die fails, the read-write (RW) performance remains substantially unchanged.

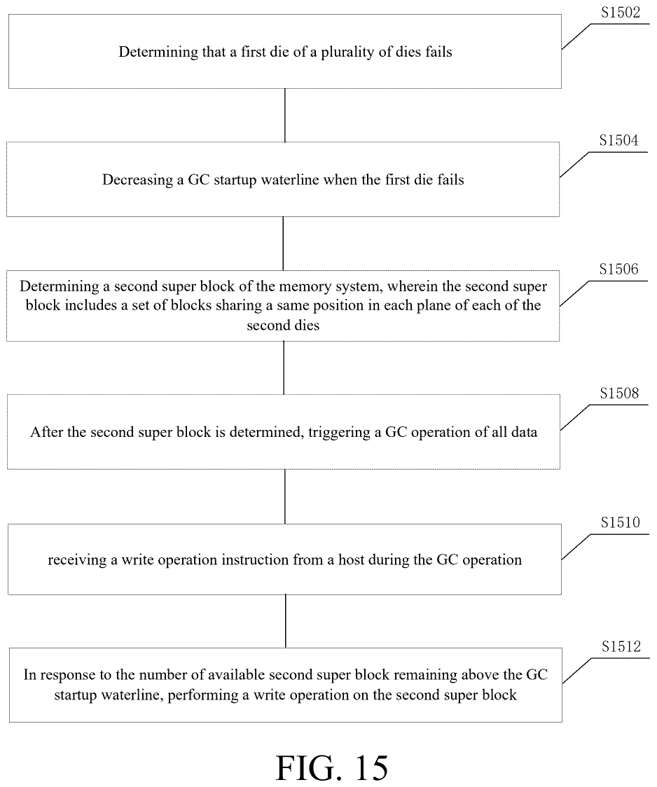

FIG. 15 illustrates a flowchart of a method of operating a memory system according to some other examples of the present disclosure. In this example, the memory system is configured with a first super block to store data.

As shown in FIG. 15, at S1502, the memory controller determines that a first die of the plurality of dies fails.

At S1504, decreasing a GC startup pipeline when the first die fails.

At S1506, determining a second super block of the memory system, wherein the second super block includes a set of blocks sharing a same position in each plane of each of the second dies.

At S1508, after the second super block is determined, triggering a GC operation of all data to write valid data in the first super block into the second super block.

At S1510, receiving a write operation command from a host during the GC operation.

At S1512, in response to the number of available second super block remaining above the GC startup waterline, performing a write operation on the second super block.

An example of a data model with improved Nand reliability based on the technical solution of the present disclosure is described below.

Assuming that the DPPM for Nand die failure is 50. The die count of one 8T SSD is 62, and the DPPM of any Nand die failure thereon is 3190.

Considering the processing of die failure, for example, the SSD can still work normally after 1 die failures (after online repair), and the DPPM of the Nand failure 1 of the SSD is about 8.

For 8T SSD, 64 dies, RAID based die (Die base RAID), the GC waterline before 1 die failure is set at 8, and the GC startup waterline after 1 die failure is set at 4, for example, the RW performance after 1 die failure can be kept substantially unchanged.

Different capacity data are shown in Table 1 below:

TABLE 1

| | | | 1- Die | 2- Die | 3- Die |
|---|---|---|---|---|---|
| | | | Failure | Failure | Failure |
| SKU | Die Count | SQ DPPM | (DPPM) | (DPPM) | (DPPM) |
| 4T | 32 | 50 | 1598 | 2 | 0 |
| 8T | 64 | 50 | 3190 | 4 | 0 |
| 16T | 128 | 50 | 6359 | 8 | 0 |
| 32T | 256 | 50 | 12638 | 16 | 0 |

In Table 1 above, “1-die failure” indicates a probability that 1 die fails, “2-die failure” indicates a probability that 2 dies fail at the same time, and “3-die failure” indicates a probability that 3 dies fail at the same time, all in units of DPPM.

In an example, there is also provided a computer-readable storage medium including an instruction, such as a controller memory including an instruction, the instruction is executable by a controller processor of a memory controller to perform the above methods. Alternatively, the computer-readable storage medium may be a ROM, Random Access Memory (RAM), CD-ROM, magnetic tape, floppy disk, optical data memory device, or the like.

In an example, there is also provided a computer program product including a computer program/instruction, the computer program/instruction, when executed by a processor, implements the method in the foregoing examples.

It should be understood that, the phrase “some examples” referred to throughout the specification means that particular features, structures, or characteristics related to the example are included in at least one example of the present disclosure. Thus, the phrases “in some examples” or “in some other examples” that appear throughout this specification do not necessarily refer to the same examples. Furthermore, these particular features, structures, or characteristics may be combined in one or more examples in any suitable manner. It should be understood that, in various examples of the present disclosure, the size of the sequence number of each process does not mean an execution sequence, and the execution sequence of each process should be determined according to its function and internal logic, and should not constitute any limitation on the implementation process of the examples of the present disclosure. The sequence numbers of the examples in the present disclosure are merely for description, and do not represent the advantages and disadvantages of the examples.

It should be noted that, in this document, the terms “include”, “comprise”, or any other variation thereof are intended to cover non-exclusive inclusion, so that a process, method, article, or device including a series of elements includes not only those elements, but also other elements not explicitly listed, or elements inherent to such a process, method, article, or apparatus. Without more limitations, an element defined by the statement “including one . . . ” does not preclude the presence of other identical element in a process, method, article, or apparatus that includes the element.

In several examples provided by the present disclosure, it should be understood that the disclosed device and method may be implemented in other manners. The device examples described above are merely illustrative, for example, division of the units is merely logical function division, and there may be another division manner in actual implementation, for example, a plurality of units or components may be combined, or may be integrated into another system, or some features may be ignored, or may not be performed. In addition, the coupling, or direct coupling, or communication connection between the components shown or discussed may be indirect coupling or communication connection through some interfaces, devices or units, and may be electrical, mechanical, or other forms.

The units described above as separate components may or may not be physically separate, and the components displayed as units may or may not be physical units; may be located in one place, or may be distributed to a plurality of network units; and some or all of the units may be selected according to actual needs to achieve the purpose of the solution of this example.

In addition, various functional units in the examples of the present disclosure may be integrated into one processing unit, or each unit may be separately used as one unit, or two or more units may be integrated into one unit; and the above integrated unit may be implemented in a form of hardware, or may be implemented in a form of hardware plus software functional units.

The above description is merely detailed implementations of the present disclosure, but the protection scope of the present disclosure is not limited thereto, and any skilled in the art may easily conceive of variations or substitutions within the technical scope of the present disclosure, which shall be covered within the protection scope of the present disclosure. Therefore, the protection scope of the present disclosure shall be defined by the protection scope of the claims.

What is claimed is:

1. A memory system, including:
a plurality of dies including a first die; and
a memory controller coupled to the plurality of dies and configured to:
determine that the first die fails;
obtain valid data of the first die based on stored redundant data; and
send a first program command sequence to second dies, wherein the first program command sequence includes a first program command and the valid data of the first die, and the second dies comprise other dies different from the first die among the plurality of dies.

2. The memory system of claim 1, wherein the memory controller is configured to obtain the valid data stored on the first die based on the redundant data stored in redundant arrays of independent disks.

3. The memory system of claim 1, wherein the memory system is configured with a first super block including a set of blocks sharing a same position in each plane of each of the plurality of dies, and the first super block includes a first block for storing check data for other blocks in the first super block.

4. The memory system of claim 3, wherein the memory controller is configured to:
after determining that the first die fails, determine a second super block of the memory system, wherein the second super block includes a set of blocks sharing a same position in each plane of each of the second dies; and
send the first program command sequence to the second dies, wherein the first program command sequence includes first physical addresses corresponding to blocks in the second super block that correspond to the second dies.

5. The memory system of claim 4, wherein the memory controller is configured to after the second super block is determined, trigger a garbage collection (GC) operation to write valid data in the first super block to the second super block.

6. The memory system of claim 4, wherein the memory controller is configured to:
after the second super block is determined, send the first program command sequence to the second dies to write the valid data of the first die to the second super block; and
in response to the valid data of the first die having been written to the second super block, trigger a garbage collection (GC) operation to write valid data of the second dies in the first super block to the second super block.

7. The memory system of claim 5, wherein the memory controller is further configured to:
determine a recovery operation mode in response to a selection of a user;
receive an operation instruction from a host during the GC operation; and
process the operation instruction based on the recovery operation mode.

8. The memory system of claim 7, wherein the memory controller is further configured to:
when the recovery operation mode is a first recovery operation mode, receive and execute a read operation instruction or a write operation instruction from the host; and
when the recovery operation mode is a second recovery operation mode, receive a read operation instruction or a write operation instruction from the host, and execute only the read operation instruction from the host.

9. The memory system of claim 5, wherein the memory controller is further configured to:
receive a write operation instruction from a host during the GC operation; and
perform a write operation on the second super block in response to a number of available second super blocks remaining above a GC startup waterline.

10. The memory system of claim 1, wherein the memory controller is further configured to receive a re-initialization instruction from a host to perform an initialization operation on the plurality of dies.

11. The memory system of claim 1, wherein the memory controller is further configured to when the first die fails, decrease a GC startup waterline.

12. The memory system of claim 1, wherein the memory controller is configured to:
receive a power-on restart failure notification for the first die during a power-on initialization process to determine that the first die fails; or
obtain an abnormal state of the first die during execution of an operation command to determine that the first die fails; or
when a number of grown bad blocks on one plane of the first die exceeds a predetermined threshold during execution of the operation command, determine that the first die fails.

13. A memory controller, including:
a controller memory configured to store a control instruction; and
a controller processor coupled to the controller memory and configured to execute the control instruction to perform a process including:
determining that a first die of a plurality of dies fails;
obtaining valid data of the first die based on stored redundant data; and
sending a first program command sequence to second dies, wherein the first program command sequence includes a first program command and the valid data of the first die, and
the second dies comprise other dies different from the first die among the plurality of dies.

14. An operating method for a memory system, including:
determining that a first die of a plurality of dies fails;
obtaining valid data of the first die based on stored redundant data; and
sending a first program command sequence to second dies, wherein the first program command sequence includes a first program command and the valid data of the first die, and the second dies comprise other dies different from the first die among the plurality of dies.

15. The operating method of claim 14, wherein obtaining the valid data of the first die based on stored redundant data includes obtaining the valid data stored on the first die based on the redundant data stored in redundant arrays of independent disks.

16. The operating method of claim 14, wherein the memory system is configured with a first super block including a set of blocks sharing a same position in each plane of each of the plurality of dies, and the first super block includes a first block for storing check data for other blocks in the first super block.

17. The operating method of claim 16, further including:
after determining that the first die fails, determining a second super block of the memory system, wherein the second super block includes a set of blocks sharing a same position in each plane of each of the second dies; and
wherein the sending a first program command sequence to second dies, wherein the first program command sequence includes a first program command and the valid data of the first die includes sending the first program command sequence to the second dies, wherein the first program command sequence includes first physical addresses corresponding to blocks in the second super block that correspond to the second dies.

18. The operating method of claim 17, wherein sending the first program command sequence to the second dies includes after the second super block is determined, triggering a garbage collection (GC) operation to write valid data in the first super block to the second super block.

19. The operating method of claim 17, wherein the sending the first program command sequence to the second dies includes:
after the second super block is determined, sending the first program command sequence to the second dies to write the valid data of the first die to the second super block; and
the method further includes:
in response to the valid data of the first die having been written to the second super block, triggering a garbage collection (GC) operation to write valid data of the second dies in the first super block to the second super block.

20. The operating method of claim 18, further including:
determining a recovery operation mode in response to a selection of a user,
receiving an operation instruction from a host during the GC operation; and
processing the operation instruction based on the recovery operation mode.
